(19) United States
(12) Patent Application Publication
(10) Pub. No.: US 2024/0209162 A1
(43) Pub. Date: Jun. 27, 2024

(54) INCORPORATING ADDITIVES INTO MOLTEN POLYMER VIA SLURRY INJECTION UPSTREAM OF A HOPPER

(71) Applicant: Chevron Phillips Chemical Company LP, The Woodlands, TX (US)

(72) Inventors: Corey W. Knight, Houston, TX (US); Kenneth A. Dooley, Porter, TX (US); Eddie Redou, Pearland, TX (US); David A. Holbrook, Dayton, TX (US)

(21) Appl. No.: 18/145,665

(22) Filed: Dec. 22, 2022

(51) Int. Cl. C08J 3/205; B29C 48/00; B29C 48/88

(52) U.S. Cl. CPC C08J 3/2056; B29C 48/022; B29C 48/88; B29C 2948/92371; B29C 2948/9238

(57) ABSTRACT

Polymer additive(s) are injected into molten polymer upstream of the hopper that feeds a molten mix of polymer with incorporated polymer additive(s) to a polymer extruder. Additive incorporation into the molten polymer is facilitated by an inlet device positioned inside the hopper, where the inlet device is configured to: i) receive a feed stream comprising a molten polymer, a liquid diluent, a polymer additive, and unreacted monomer, ii) provide one or more solid surfaces for incorporating the polymer additive into the molten polymer, and iii) direct the molten polymer and the polymer additive into the molten polymer pool that is in the hopper.

### FIELD OF THE DISCLOSURE

The present disclosure generally relates to the incorporation of additives into a polymer.

### BACKGROUND

Additives are commonly added to a polymer prior to or during extrusion of the polymer into extrudate, such as pellets or film. For example, additives can be added to solid polymer in the form of granules or fluff prior to feeding the solid polymer to an extruder; or, additives can be added to molten polymer that moves through an extruder after solid polymer is fed into an extruder and melted in the extruder. For some polymers, the polymer is fed in molten state to the extruder, for example, in the extrusion of some low density polyethylene (LDPE). Additives can be combined with the molten polymer prior to feeding the molten polymer to the extruder.

When a hopper is used upstream of the extruder, the hopper can hold a pool of molten polymer. A flow of molten polymer feeds into the pool, and additives are typically injected into the pool of molten polymer in the hopper for incorporation of the additives into the molten polymer. Additive injection into the polymer pool can aid in additive incorporation and mixing in the pool, for subsequent flow of the molten mix to an extruder. It was found that when injecting a slurry of polymer additives in a diluent directly into the polymer pool, the diluent did not adequately bubble out of the polymer pool. Instead, the diluent was trapped in the polymer pool, flowed from the hopper to the extruder with the molten mix, and leaked from the extruder.

There is a need for techniques that can adequately mix additives into molten polymer and, when a vaporizable diluent is used in a slurry of the polymer additive(s), avoids the drawbacks of direct injection into the molten polymer pool.

### SUMMARY

Disclosed is a process that can include injecting a slurry including a liquid diluent and one or more polymer additive into a polymer stream including a molten polymer and unreacted monomer, to form a feed stream including the molten polymer, the slurry, and the unreacted monomer; introducing the feed stream into a hopper; withdrawing, from the hopper, a molten mix including the molten polymer and the polymer additive; and extruding the molten mix into a polymer extrudate.

Disclosed is a polymer hopper system that can include a hopper configured to contain a molten polymer pool; and an inlet device coupled to an inlet of the hopper, wherein the inlet device is configured to: i) receive a feed stream including a molten polymer, a liquid diluent, a polymer additive, and unreacted monomer, ii) provide one or more solid surfaces for incorporating the polymer additive into the molten polymer, and iii) direct the molten polymer and the polymer additive into the molten polymer pool.

Disclosed is a polymer hopper system that can include a hopper containing a molten polymer pool; and an inlet device coupled to an inlet of the hopper, wherein the inlet device comprises an inlet shroud. The inlet shroud comprises a first portion having an end fluidly coupled with the inlet of the hopper; and a second portion having i) an end connected to an opposite end of the first portion, and ii) an opposite end that is open to an interior of the hopper. The first portion has a top piece, a bottom piece, a side piece, and an opposite side piece, wherein the side piece of the first portion is a portion of an inner wall of the hopper. The second portion has a top piece, a side piece, and an opposite side piece, wherein the side piece of the second portion is another portion of the inner wall of the hopper. A bottom of the second portion is open to the interior of the hopper.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1 illustrates a schematic diagram of an apparatus having an inlet device that incorporates one or more polymer additives into a molten polymer prior to the molten polymer flowing into a molten polymer pool that is contained in a hopper.

FIG. 2 illustrates a cut-away elevational view of the hopper having the inlet device of the apparatus embodied as an inlet pipe coupled to a vapor liquid gravity separator.

FIG. 3 illustrates a cut-away elevational view of the hopper having the inlet device of the apparatus embodied as an inlet pipe coupled to a cyclone separator.

FIG. 4 illustrates a cut-away elevational view of the hopper having the inlet device of the apparatus embodied as an inlet shroud.

FIG. 5 illustrates an isolated perspective view of the inlet shroud of FIG. 4.

FIG. 6 illustrates a top view of the inlet shroud of FIG. 4.

### DETAILED DESCRIPTION

The term “stream” as used herein refers to a composition in a gas phase, in a liquid phase, in a solid phase, or any combination of phases. The term “stream” can additionally refer to and imply associated equipment, such as conduit, line, and pipe that is used to move the composition from one location to another. Alternatively, the term “stream” refers only to the composition contained within the equipment.

“Liquid diluent” as used herein includes compositions that are molten or in a liquid phase under the operating conditions described herein. Liquid diluent can include a hydrocarbon that is in liquid phase at the point of additive injection, a molten wax, or a combination thereof, for example.

“Molten polymer” as used herein refers to a polymer in a molten, flowable state. Examples of polymers that can be used as a molten polymer within the scope of this disclosure include, but are not limited to, olefin homopolymers and copolymers. Examples of olefin polymers includes, but are not limited to, low density polyethylene, medium density polyethylene, high density polyethylene, ethylene-1-butene copolymers, ethylene-1-hexene copolymers, and polypropylene.

“Post-consumer recycled plastic” as used herein refers to a type of plastic that has been reprocessed from other products that have been used and thrown away by consumers.

“Post-consumer material” refers to a finished material which would typically be disposed of as a solid waste, having reached its intended end-use and completed its life cycle as a consumer item, and does not include manufacturing or converting wastes.

Disclosed herein are apparatus and methods that incorporate one or more polymer additives into a molten polymer prior to the molten polymer flowing into a molten polymer pool that is contained in a hopper. The apparatus and methods can utilize an inlet device for the hopper that is configured to i) receive a feed stream comprising the molten polymer, a liquid diluent, and the one or more polymer additives, ii) provide one or more solid surfaces for incorporating the polymer additive(s) into the molten polymer, and iii) direct the molten polymer and the polymer additive(s) into the molten polymer pool. In aspects, the apparatus and methods incorporate polymer additive(s) into molten polymer while vaporizing the liquid diluent in the inlet device, to separate the diluent from the polymer additive(s) and molten polymer. The inlet devices disclosed herein accomplish polymer additive incorporation and vapor separation by feeding the components of the feed stream into the inlet device in a direction of flow that is different than a direction of flow by which components leave the inlet device.

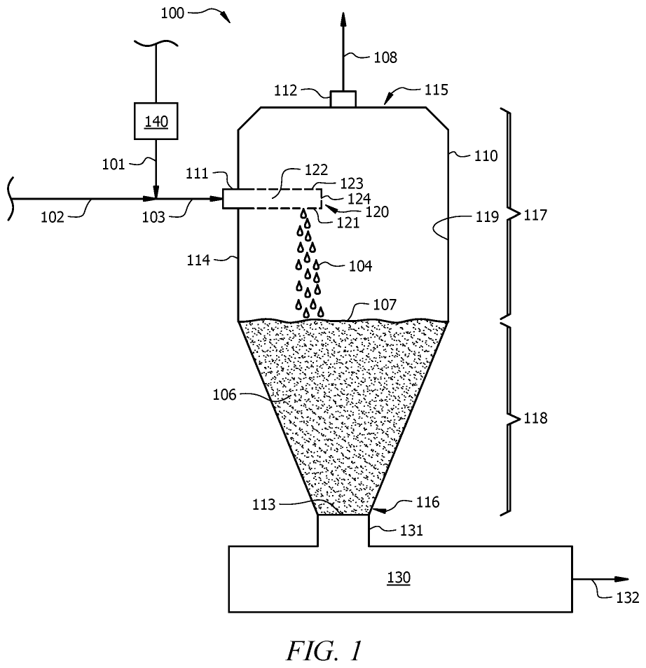

FIG. 1 illustrates a schematic diagram of an apparatus 100 having an inlet device 120 that incorporates one or more polymer additives into a molten polymer prior to the molten polymer flowing into a molten polymer pool 106 that is contained in a hopper 110. The apparatus 100 includes a hopper 110 containing a molten polymer pool 106 and an inlet device 120 coupled to an inlet 111 of the hopper 110. The apparatus 100 can also include an extruder 130 coupled to a molten mix outlet 113 of the hopper 110 and a polymer additive injector 140 coupled to the inlet 111 of the hopper 110.

The hopper 110 is a vessel configured i) to contain a molten polymer pool 106, ii) receive a feed stream 103 comprising a molten polymer, a slurry of liquid diluent and polymer additive, and an unreacted monomer (e.g., olefin monomer such as ethylene, propylene, 1-butene, 1-hexene, or combinations thereof) via an inlet 111 of the hopper 110, iii) emit a vapor from a first outlet 112 (also referred to herein as vapor outlet) of the hopper 110, and iv) emit a molten mixture from a second outlet 113 (also referred to herein as molten mix outlet) of the hopper 110. The inlet 111 of the hopper 110 can be positioned on a side 114 of the hopper 110, the first outlet 112 can be positioned on a top 115 of the hopper 110, and the second outlet 113 can be positioned on a bottom 116 of the hopper 110. In aspects, the hopper 110 can be a cylindrically-shaped vessel, optionally with rounded top 115 and a rounded bottom 116. In other aspects, the hopper 110 can a cylindrical portion 117 and a conical portion 118, where the cylindrical portion 117 is above the conical portion 118.

An operating temperature of the hopper 110 can be a temperature in a range of from about 150° C. to about 280° C.; alternatively, in a range of from about 175° C. to 250° C. Temperatures in these ranges can provide a molten mix containing the molten polymer for adequate flow from the hopper 110 to the extruder 130. Temperatures in these ranges can also adequately vaporize some of the liquid diluents (e.g., when embodied as saturated hydrocarbons) when the liquid diluents enter the inlet device 120 inside the hopper 110.

The inlet device 120 is configured to: i) receive a feed stream comprising a molten polymer, a liquid diluent, a polymer additive, and unreacted monomer, ii) provide one or more solid surfaces for incorporating the polymer additive into the molten polymer, and iii) direct the molten polymer and the polymer additive into the molten polymer pool 106.

In aspects, the inlet device 120 can be further configured to reduce a velocity of components of the feed stream 103 that are received into the inlet device 120 via the inlet 111 of the hopper 110. The feed stream 103 can contain a vapor portion containing the unreacted monomer in vapor phase and a slurry portion containing the molten polymer, the liquid diluent, and the polymer additive. Reduction of the velocity of the feed stream 103 within the inlet device 120 can prevent a transport or carryover of the polymer additive into the vapors (e.g., unreacted monomer) in the inlet device 120, and out of the hopper 110. In some aspects, the inlet device 120 can be further configured such that the liquid diluent that is received from the feed stream 103 into the inlet device 120 can vaporize within the inlet device 120 (e.g., for liquid diluents having a boiling point that is lower than the temperature of the interior of the hopper 110), and the inlet device 120 can prevent a transport of the polymer additive into the vapor (e.g., unreacted monomer and vaporized diluent) in the inlet device 120. In further aspects, the inlet device 120 can prevent splatter of the molten polymer onto the inner wall 119 of the hopper 110 because the one or more solid surfaces of the inlet device 120 accept any splatter of the molten polymer and direct the molten polymer and polymer additive to the molten polymer pool 106. In further aspects, the reduction of velocity controls the expansion of vapors obtained and/or derived from the feed stream 103 by limiting the expansion volume to the volume of the inlet device 120 (as opposed to the entire volume of the hopper 110).

In aspects, the inlet device 120 can be coupled to the inlet 111 of the hopper 110 and connected to an inner wall 119 of the hopper 110. In further aspects, the inlet device 120 is coupled to the inlet 111 and connected to the inner wall 119 in the cylindrical portion 117 of the hopper 110.

In aspects, a bottom 121 of the inlet device 120 is positioned above a top surface 107 of the molten polymer pool 106. The inlet device 120 can have an inlet end 122 that is fluidly coupled with the inlet 111 of the hopper 110 and an outlet end (e.g., bottom 121, top 123, side 124, or combinations thereof) in fluid communication with an interior of the hopper 110 that is above the top surface 107 of the molten polymer pool 106. For example, the inlet device 120 can be configured such that the bottom 121 and the top 123 are in fluid communication with the interior of the hopper 110; alternatively, the inlet device 120 can be configured such that the bottom 121 and the side 124 are in fluid communication with the interior of the hopper 110; alternatively, the inlet device 120 can be configured such that the top 123 and the side 124 are in fluid communication with the interior of the hopper 110.

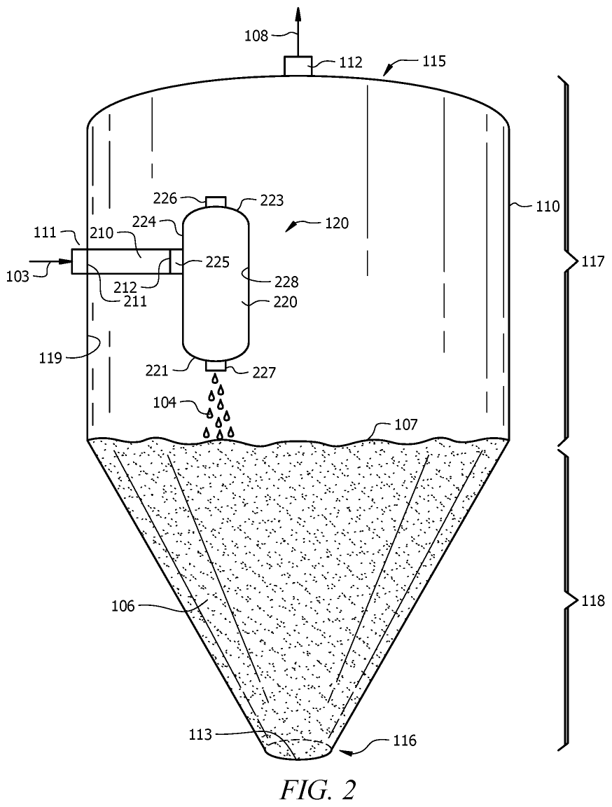

In aspects, the inlet device 120 can be embodied as an inlet pipe coupled to a vapor liquid gravity separator (see FIG. 2), and in such embodiments, the inlet device 120 can be configured such that the bottom 121 and the top 123 are in fluid communication with the interior of the hopper 110.

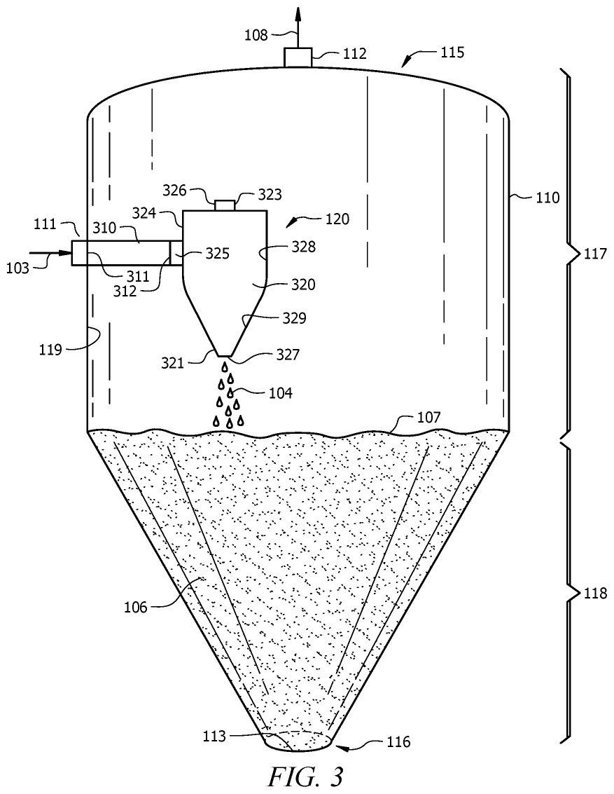

In other aspects, the inlet device 120 can be embodied as an inlet pipe coupled to a cyclone separator (see FIG. 3), and in such embodiments, the inlet device 120 can be configured such that the bottom 121 and the top 123 are in fluid communication with the interior of the hopper 110.

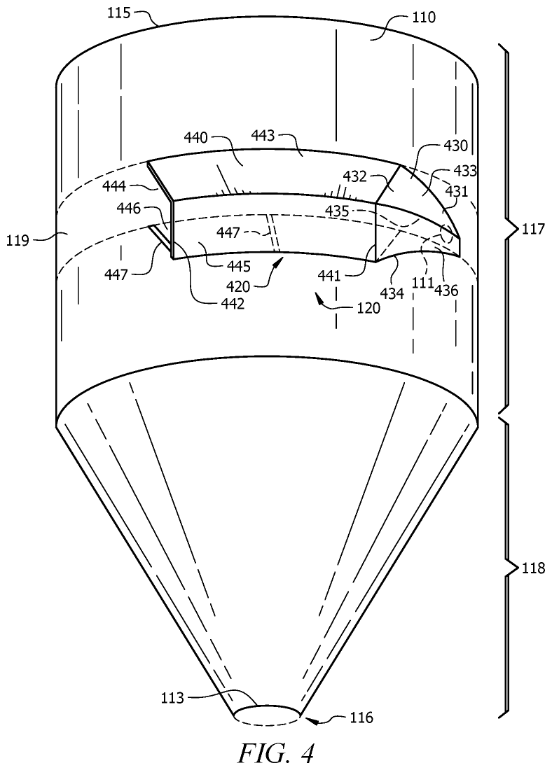

In other aspects, the inlet device 120 can be embodied as an inlet shroud (see FIG. 4), and in such embodiments, the inlet device 120 can be configured such that the bottom 121 and the side 124 are in fluid communication with the interior of the hopper 110.

The extruder 130 can be coupled to the second outlet 113 of the hopper 110. For example, the extruder 130 can have an inlet 131 that is directly connected to the second outlet 113 of the hopper 110; alternatively, the inlet 131 of the extruder 130 can be coupled (e.g., indirectly connected) to the second outlet 113 of the hopper 110 via a transfer conduit or other equipment for transferring the molten mix that emits from the second outlet 113 of the hopper 110 to the inlet 131 of the extruder 130.

The extruder 130 can be embodied as any polymer extruder that is configured to cool the molten mix received at the inlet 131 into solid polymer, and cut the solid polymer into extrudate (e.g., polymer pellets), on a continuous basis. The extrudate can flow from the extruder 130 via extrudate stream 132. The extruder 130 can maintain the temperature of the molten polymer mixture and convey the molten mix through a pelletizing die under pressure where it is cut (e.g., with knives) to form the polymer extrudate. The polymer extrudate can then be cooled (e.g., in air or water) at or near the discharge region of the extruder 130. The polymer extrudate may then be transported to a product load-out area for further use such as storing, blending with other pellets, and/or loading into railcars, trucks, bags, supersacks, or other containers for distribution to customer(s).

The polymer additive injector 140 can be embodied as any slurry injector that is configured to inject a slurry of polymer additive(s) into the molten polymer flowing either in stream 102 to form the feed stream 103 or flowing in the inlet 111 of the hopper 110. In either embodiment, the polymer additive injector 140 can be positioned upstream of the hopper 110 and fluidly coupled to the inlet 111 of the hopper 110. The polymer additive injector 140 can be a retractable lance injector, for example. In some aspects, the polymer additive injector 140 can include an isolation valve between the retractable lance injector and the molten polymer stream 102, such that the polymer additive stream 101 can be fluidly isolated from the flow of molten polymer, for example, to remove the retractable lance injector for maintenance without stopping flow of molten polymer in stream 102. “Polymer additive” and “additive” as used herein refer to an antioxidant, an antiblock additive, a surfactant, an acid scavenger, a slip additive, a colorant, a filler, a processing aid, a UV inhibitor, or any combination thereof.

The apparatus 100 operates on a continuous basis to inject a slurry containing a polymer additive (or multiple polymer additives) from polymer additive injector 140 into a molten polymer stream 102 to form a feed stream 103 that is connected to the inlet 111 of the hopper 110.

The polymer additive stream 101 can be any length of conduit or a conduit coupled that connects an outlet of the polymer additive injector 140 to the molten polymer stream 102; alternatively, the polymer additive stream 101 can be embodied as a flange or outlet of the polymer additive injector 140 that connected to the molten polymer stream 102. The polymer additive stream 101 contains a slurry containing one or more polymer additive(s) and a carrier, referred to herein as a liquid diluent. The polymer additive(s) can be suspended, dispersed, or dissolved in the liquid diluent to form the slurry.

The molten polymer stream 102 contains molten polymer and unreacted monomer that flow from a polymerization reactor. In aspects, the polymerization reactor can include a high-pressure autoclave reactor, a tubular reactor, or combinations thereof, that is configured to polymerize an olefin monomer in presence of a polymerization catalyst at polymerization conditions to produce a reaction mixture comprising unreacted monomer and molten polymer. In aspects, the polymerization reactor can include a low-pressure fluidized bed (gas phase) reactor, loop slurry reactor, solution phase polymerization reactor, or combinations thereof, that is configured to polymerize an olefin monomer in presence of a polymerization catalyst at polymerization conditions to produce a reaction mixture comprising unreacted monomer and polymer. In aspects, the monomer can be an olefin monomer such as ethylene, propylene, 1-butene, 1-hexene, 1-octene, 1-decene, 4-methyl-1-pentene, vinyl acetate, butyl acrylate, or combinations thereof. In aspects, the polymer can be an ethylene homopolymer, an ethylene copolymer, a propylene homopolymer, a propylene copolymer, a butene homopolymer, a butene copolymer, a hexene homopolymer, a hexene copolymer, or combinations thereof. In aspects, the monomer can be ethylene and the molten polymer can be molten low density polyethylene (LDPE).

The feed stream 103 contains the molten polymer, the slurry of liquid diluent and the polymer additive(s), and the unreacted monomer. The feed stream 103 is connected to the inlet 111 of the hopper 110; thus, the polymer additive injection occurs at a location upstream of the molten polymer pool 106 in the hopper 110, and the feed stream 103 feeds the contents into the inlet 111 of the hopper 110. The contents flow through the inlet 111 and into the inlet device 120, where the polymer additive(s) mix into the molten polymer within the inlet device 120. Unreacted monomer in vapor phase in the feed stream 103 flows into the inlet device 120 and flows out of the bottom 121, the top 123, the side 124, or combinations thereof of the inlet device 120 (depending on the embodiment of the inlet device 12). The unreacted monomer vapor can rise in the hopper 110 and flow out of the first outlet 112 of the hopper 110 via the vapor stream 108.

In some aspects, the polymer additive(s) is injected in a slurry containing a molten wax as the carrier for the polymer additive(s). The wax can mix with the molten polymer, along with incorporation of the polymer additive(s) into the molten polymer, in the inlet device 120. The inlet device 120 can direct the mixture 104 of molten polymer, wax, polymer additive(s) into the molten polymer pool 106 that is below the inlet device 120 inside the hopper 110. In these aspects, the vapor stream 108 contains unreacted monomer vapor, and the vapor stream 108 can flow to a monomer recovery unit, where unreacted monomer can be recovered and recycled to a polymerization reactor.

In alternative aspects, the polymer additive(s) is injected in a slurry containing liquid diluent as the carrier for the polymer additive(s). The liquid diluent can vaporize within the inlet device 120 at the operating temperature of the inlet device 120 (e.g., of the hopper 110 since the inlet device 120 is contained in the hopper 110). Examples of vaporizable liquid diluents include saturated hydrocarbons (e.g., a C₉ saturated hydrocarbon, a C₁₀ saturated hydrocarbon, a C₁₁ saturated hydrocarbon, or combinations thereof). The slurry and molten polymer flow in the feed stream 103, through the inlet 111 of the hopper 110, and into the inlet device 120. Inside the inlet device 120, the liquid diluent vaporizes and separates from the polymer additive(s) and molten polymer. The vaporized diluent can flow out of the bottom 121, the top 123, the side 124, or combinations thereof of the inlet device 120 (depending on the embodiment of the inlet device 12), and can then rise in the hopper 110 and flow out of the first outlet 112 of the hopper 110 via the vapor stream 108 containing the unreacted monomer(s) and the vaporized diluent. The polymer additive(s) can incorporate into the molten polymer while the molten polymer is present in the inlet device 120. The inlet device 120 can direct the mixture 104 of molten polymer and polymer additive(s) into the molten polymer pool 106 that is below the inlet device 120 inside the hopper 110. In these aspects, the vapor stream 108 contains unreacted monomer vapor and vaporized diluent, and the vapor stream 108 can be configured to transfer the unreacted monomer vapor and vaporized diluent to a monomer recovery unit for separation of the vapor stream 108 into unreacted monomer (e.g., that can be recycled to a polymerization reactor) and diluent (e.g., that can be recycled for use in the additive slurry).

The apparatus 100 can operate such that a portion of the molten polymer pool 106 is continuously withdrawn from the second outlet 113 of the hopper 110. The portion of the molten polymer pool 106 that is withdrawn can be referred to herein as a molten mix comprising the molten polymer, the polymer additive(s), and optionally, diluent that is used as carrier for the polymer additive(s) during additive injection (e.g., wax diluent that does not vaporize at operating temperature of the hopper 110).

The withdrawn molten mix can be extruded into a polymer extrudate in the extruder 130.

In some aspects, a post-consumer recycled (PCR) polymer can be combined with the molten polymer flowing in feed stream 103, with the molten mix flowing in inlet 131 to the extruder 130, with the extrudate in extrudate stream 132, or combinations thereof. The PCR polymer can be combined with the molten polymer, molten mix, extrudate, or combinations thereof, such that the PCR polymer is present in the combined polymer in a range of from about 0.1 wt % to about 30 wt %; alternatively, from about 5 wt % to about 20 wt %, based on a total weight of the combined polymer. For example, a PCR polymer can be combined with virgin LDPE to form the combined polymer. In some aspects, the LDPE-PCR combined polymer can form an end-use product having substantially the same physical property value(s), such as within 10% of the physical property value(s) of an end-use product made from virgin LDPE.

FIG. 2 illustrates a cut-away elevational view of the hopper 110 having the inlet device 120 of the apparatus 100 embodied as an inlet pipe 210 coupled to a vapor liquid gravity separator 220.

As can be seen, an end 211 of the inlet pipe 210 can be connected to the inner wall 119 of the hopper 110, in the cylindrical portion 117 of the hopper 110 at a location that is above the top surface 107 of the molten polymer pool 106. The end 211 of the inlet pipe 210 is fluidly coupled to the inlet 111. An opposite end 212 of the inlet pipe 210 is connected to an inlet 225 on the side 224 of the vapor liquid gravity separator 220. The vapor liquid gravity separator 220 is a cylindrically-shaped vessel having the inlet 225, a first outlet 226 (also referred to as the vapor outlet of the vapor liquid gravity separator 220), and a second outlet 227 (also referred to as the molten mix outlet of the vapor liquid gravity separator 220). The vessel of the vapor liquid gravity separator 220 can have flat or rounded top and bottom. The inlet pipe 210 is illustrated as extending horizontally within the cylindrical portion 117 of the hopper 110; however, it contemplated that the inlet pipe 210 can extend at an angle from the inner wall 119 of the hopper 110 such that the opposite end 212 is above or below the end 211. It is also contemplated that the length of the inlet pipe 210 can be such that the second outlet 227 of the vapor liquid gravity separator 220 is positioned in the center of the hopper 110 or off-center in the hopper 110 (which is illustrated in FIG. 2).

The method of operating of the hopper 110 and vapor liquid gravity separator 220 in FIG. 2 is similar as described for the hopper 110 and inlet device 120 in the apparatus 100 in FIG. 1. The feed stream 103 feeds molten polymer, unreacted monomer(s), and a slurry of polymer additive(s) in liquid diluent to the hopper 110 via the inlet 111. The components of the feed stream 103 continue through the inlet 111 and into the inlet pipe 210. The components transfer through the inlet pipe 210 and into the side 224 of the vapor liquid gravity separator 220 via the inlet 225. Inside the vapor liquid gravity separator 220, the components reduce velocity, and the molten polymer and polymer additive(s) impact against the solid surfaces (e.g., the inner wall 228 of the bottom 221, top 223, and side 224) of the vapor liquid gravity separator 220. The impact helps to incorporate the polymer additive(s) into the molten polymer. By principles of gravity separation, unreacted monomer and any vaporized diluent rise in the vapor liquid gravity separator 220 and flow out of the first outlet 226 of the vapor liquid gravity separator 220. The vapor continues to rise in the hopper 110 and flows out of the hopper 110 via vapor stream 108. Molten polymer and polymer additive(s) incorporated therein, as well as any liquid diluent that is not vaporized, flow downward in the vapor liquid gravity separator 220 and out of the second outlet 227 of the vapor liquid gravity separator 220. The components that flow out of the second outlet 227 fall into the molten polymer pool 106, adding to the molten mix in the conical portion 118 of the hopper 110.

As can be seen in FIG. 2, the vapor liquid gravity separator 220 is entirely contained in the interior of the cylindrical portion 117 of the hopper 110, and the volume of the vapor liquid gravity separator 220 is substantially smaller than the volume of the cylindrical portion 117 of the hopper 110.

FIG. 3 illustrates a cut-away elevational view of the hopper 110 having the inlet device 120 of the apparatus 100 embodied as an inlet pipe 310 coupled to a cyclone separator 320.

As can be seen, an end 311 of the inlet pipe 310 can be connected to the inner wall 119 of the hopper 110, in the cylindrical portion 117 of the hopper 110 at a location that is above the top surface 107 of the molten polymer pool 106. The end 311 of the inlet pipe 310 is fluidly coupled to the inlet 111 of the hopper 110. An opposite end 312 of the inlet pipe 310 is connected to an inlet 325 on the side 324 of the cyclone separator 320. The cyclone separator 320 is a cyclone type vessel having the inlet 325, a first outlet 326 (also referred to as the vapor outlet of the cyclone separator 320), and a second outlet 327 (also referred to as the molten mix outlet of the cyclone separator 320). The inlet pipe 310 is illustrated as extending horizontally within the cylindrical portion 117 of the hopper 110; however, it is contemplated that the inlet pipe 310 can extend at an angle from the inner wall 119 of the hopper 110 such that the opposite end 312 is above or below the end 311. It is also contemplated that the length of the inlet pipe 310 can be such that the second outlet 327 of the cyclone separator 320 is positioned in the center of the hopper 110 or off-center in the hopper 110 (which is illustrated in FIG. 3).

The method of operating of the hopper 110 and cyclone separator 320 in FIG. 3 is similar as described for the hopper 110 and the inlet device 120 in the apparatus 100 in FIG. 1. The feed stream 103 feeds molten polymer, unreacted monomer(s), and a slurry of polymer additive(s) in liquid diluent to the hopper 110 via the inlet 111. The components of the feed stream 103 continue through the inlet 111 and into the inlet pipe 310. The components transfer through the inlet pipe 310 and into the side 324 of the cyclone separator 320 via the inlet 325. Inside the cyclone separator 320, the components reduce velocity, and the molten polymer and polymer additive(s) impact against the solid surfaces (e.g., the inner wall 328 of the bottom 321, top 323, and side 324) of the cyclone separator 320. The impact helps to incorporate the polymer additive(s) into the molten polymer. By principles of centrifugal separation, unreacted monomer and any vaporized diluent rise in the center of the cyclone separator 320 and flow out of the first outlet 326 of the cyclone separator 320. The vapor continues to rise in the hopper 110 and flows out of the hopper 110 via vapor stream 108. Molten polymer and polymer additive(s) incorporated therein, as well as any liquid diluent that is not vaporized, flow in cyclone flow pattern downwardly along the conically-shaped wall 329 of the cyclone separator 320, separating from the vapor by centrifugal forces. The components flow out of the second outlet 327 of the cyclone separator 320. The components that flow out of the second outlet 327 fall into the molten polymer pool 106, adding to the molten mix in the conical portion 118 of the hopper 110.

As can be seen in FIG. 3, the cyclone separator 320 is entirely contained in the interior of the cylindrical portion 117 of the hopper 110, and the volume of the cyclone separator 320 is substantially smaller than the volume of the cylindrical portion 117 of the hopper 110.

FIG. 4 illustrates a cut-away elevational view of the hopper 110 having the inlet device 120 of the apparatus 100 embodied as an inlet shroud 420. The inlet shroud 420 is connected to the inner wall 119 of the hopper 110, and in aspects, to the inner wall 119 of the cylindrical portion 117 of the hopper 110. Different from the vapor liquid gravity separator 220 and cyclone separator 320, the solid surfaces of the inlet shroud 420 include portions of the inner wall 119 of the hopper 110 (explained in more detail below).

The inlet shroud 420 has a first portion 430 connected to a second portion 440. The first portion 430 has an end 431 fluidly coupled with inlet 111 of the hopper 110 (and with the feed stream 103) and an opposite end 432 connected to an end 441 of the second portion 440. The second portion 440 additionally has an opposite end 442 that is in fluid communication with the interior of the hopper 110. Put another way, the opposite end 442 is open to the interior of the hopper 110.

The first portion 430 has a top piece 433, a bottom piece 434, a side piece 435, and an opposite side piece 436. The side piece 435 is a portion of the inner wall 119 of the hopper 110. The top piece 433, the bottom piece 434, the side piece 435, and the opposite side piece 436 collectively provide an enclosure that forms the first portion 430 of the inlet shroud 420.

The second portion 440 has a top piece 443, a side piece 444, and an opposite side piece 445. The side piece 444 is another portion of the inner wall 119 of the hopper 110. In aspects, the second portion 440 of the inlet shroud 420 has no bottom piece and no end piece, and the bottom 446 and opposite end 442 of the second portion 440 are in fluid communication with the interior of the hopper 110. Put another way, the opposite end 442 and the bottom 446 are open to the interior of the hopper 110. Because the opposite end 442 and the bottom 446 of the second portion 440 are open and in fluid communication with the interior of the hopper 110, one or more support strut 447 can connect the opposite side piece 445 of the second portion 440 to the inner wall 119 of the hopper 110. While support struts 447 are illustrated, other equipment for connecting the opposite side piece 445 to the inner wall 119 of the hopper 110 can be used. In aspects, the support struts 447 are connected to the opposite side piece 445 but are not connected to the inner wall 119 of the hopper 110. In these aspects, an end of the support struts 447 rests against the inner wall 119 of the hopper 110. Alternatively, the end of the support struts 447 connects to the inner wall 119, e.g., via welds.

The method of operating of the hopper 110 and inlet shroud 420 in FIG. 4 is similar as described for the hopper 110 and the inlet device 120 in the apparatus 100 in FIG. 1. The feed stream 103 feeds molten polymer, unreacted monomer(s), and a slurry of polymer additive(s) in liquid diluent to the hopper 110 via the inlet 111 of the hopper 110. The components of the feed stream 103 continue through the inlet 111 and into the first portion 430 of the inlet shroud 420. In the first portion 430 the vapors can begin to expand. The components continue flow through the first portion 430 and into the second portion 440 of the inlet shroud 420. Inside the first portion 430, the second portion 440, or both the first portion 430 and the second portion 440, the components reduce velocity, and the molten polymer and polymer additive(s) impact against the solid surfaces of the interior of the inlet shroud 420 (e.g., combinations of: the top piece 433, bottom piece 434, and the opposite side piece 436 of the first portion 430; the top piece 443 and the opposite side piece 445 of the second portion 440; and the portion(s) of the inner wall 119 of the hopper 110 that form part of the first portion 430 and the second portion 440 of the inlet shroud 420). For example, depending on the direction of flow of components into the inlet 111 of the hopper 110, the components can flow in a direction that first impacts the opposite side piece 436 of the first portion 430 of the inlet shroud 420. The vapors being to separate from the slurry, and continuous flow of components into the inlet shroud 420 pushes the components further into the second portion 440 of the inlet shroud 420 where the molten polymer can impact the top piece 433, the side piece 444, and the opposite side piece 445 of the second portion 440. The impact(s) helps to incorporate the polymer additive(s) into the molten polymer and provide surface area for vaporization of diluent that is entrained in the molten polymer. Vapors containing unreacted monomer and any vaporized diluent rise in the inlet shroud 420 and flow out of the opposite end 442 of the second portion 440 of the inlet shroud 420. The vapor continues to rise in the hopper 110 and flows out of the hopper 110 via vapor stream 108. Molten polymer and polymer additive(s) incorporated therein, as well as any liquid diluent that is not vaporized, can drop downward in the second portion 440 of the inlet shroud 420 and out of the bottom 446 of the second portion 440 of the inlet shroud 420. The components that flow out of the bottom 446 fall into the molten polymer pool 106, adding to the molten mix in the conical portion 118 of the hopper 110.

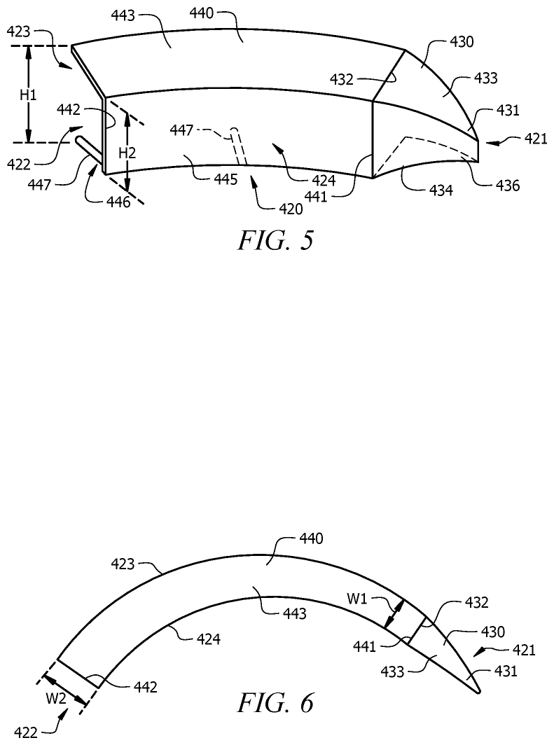

FIG. 5 illustrates an isolated perspective view of the inlet shroud 420 of FIG. 4. The inlet shroud 420 can generally having an inlet end 421, an outlet end 422, a side 423, and an opposite side 424. The first portion 430 can be seen connected to the second portion 440 at a location that is between the inlet end 421 and the outlet end 422. Moreover, each of the first portion 430 and the second portion 440 forms part of the side 423 and the opposite side 424 of the inlet shroud 420. The first portion 430 has the top piece 433, the bottom piece 434, and the opposite side piece 436 that form a three-sided enclosure. In operation, the first portion 430 is a four-sided enclosure, and in the isolated view of FIG. 5, the fourth side of the first portion 430, the side piece 435, is missing because a portion of the inner wall 119 of the hopper 110 is the side piece 435 of the first portion 430. The second portion 440 has the top piece 443 and the opposite side piece 445 that form a two-sided enclosure, with the opposite end 442 and the bottom 446 being open. In operation, the second portion 440 is a three-sided enclosure, and in the isolated view of FIG. 5, the third side of the second portion 440, the side piece 444, is missing because the other portion of the inner wall 119 of the hopper 110 is the side piece 444 of the second portion 440.

In FIG. 5, it can be seen that the side 423 of the inlet shroud 420 has a height H1 that is greater than a height H2 of the opposite side 424 of the inlet shroud 420. In aspects, the height H1 can range from about 28 inches (71.12 cm) to about 36 inches (91.44 cm), and the height H2 can range from about 22 inches (55.88 cm) to about 28 inches (71.12 cm).

FIG. 6 illustrates an isolated top view of the inlet shroud 420 of FIG. 4. The view in FIG. 6 shows the top piece 433 of the first portion 430 and the top piece 443 of the second portion 440 of the inlet shroud 420. As can be seen, a width of the inlet shroud 420 increases in a direction that is from the inlet end 421 of the inlet shroud 420 to the outlet end 422 of the inlet shroud 420. The side 423 of the inlet shroud 420 that connects to the inner wall 119 of the hopper 110 has a curvature that matches the inner wall 119 of the hopper 110. The opposite side 424 of the inlet shroud 420 can have a curvature, and the curvature is configured such that the width of the inlet shroud 420 increases in a direction that is from the inlet end 421 of the inlet shroud 420 to the outlet end 422 of the inlet shroud 420.

As can be seen, the end 441 of the second portion 440 has a width W1 that is less than a width W2 of the opposite end 442 of the second portion 440. The width W1 can range from about 6 inches (15.2 cm) to about 12 inches (30.5 cm); alternatively, from about 8 inches (20.3 cm) to about 10 inches (25.4 cm). The width W1 can range from about 10 inches (25.4 cm) to about 14 inches (35.6 cm); alternatively, can be about 12 inches (30.5 cm).

### ADDITIONAL DESCRIPTION

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the detailed description of the present disclosure. The disclosures of all patents, patent applications, and publications cited herein are hereby incorporated by reference.

Aspects of processes and apparatus have been described. The following are non-limiting, specific aspects in accordance with the present disclosure:

Aspect 1. A process comprising: injecting a slurry comprising a liquid diluent and a polymer additive into a polymer stream comprising a molten polymer and unreacted monomer, to form a feed stream comprising the molten polymer, the slurry, and the unreacted monomer; introducing the feed stream into a hopper; withdrawing, from the hopper, a molten mix comprising the molten polymer and the polymer additive; and extruding the molten mix into a polymer extrudate.

Aspect 2. The process of Aspect 1, wherein introducing comprises: flowing the feed stream into an inlet device, wherein the inlet device is coupled to an inlet of the hopper.

Aspect 3. The process of Aspect 2, further comprising: incorporating the polymer additive into the molten polymer while the molten polymer is present in the inlet device.

Aspect 4. The process of any of Aspects 2 to 3, further comprising: directing, by the inlet device, the molten polymer and the polymer additive into a molten polymer pool contained in the hopper below the inlet device.

Aspect 5. The process of any of Aspects 2 to 4, further comprising: vaporizing the liquid diluent within the inlet device to form a vaporized diluent; and recovering, from the hopper, a vapor stream comprising the unreacted monomer and the vaporized diluent.

Aspect 6. The process of any of Aspects 2 to 5, wherein the inlet device comprises an inlet shroud, an inlet pipe coupled to a cyclone separator, or an inlet pipe coupled with a vapor liquid gravity separator.

Aspect 7. The process of any of Aspects 1 to 6, wherein the molten polymer comprises an ethylene homopolymer, an ethylene copolymer, a propylene homopolymer, a propylene copolymer, a butene homopolymer, a butene copolymer, a hexene homopolymer, a hexene copolymer, low density polyethylene, medium density polyethylene, high density polyethylene, ethylene-1-butene copolymers, ethylene-1-hexene copolymers, 1-butene,-1-hexene copolymers, polypropylene, ethylene-propylene copolymers, propylene-1-butene copolymers, propylene-1-hexene copolymers, or combinations thereof.

Aspect 8. The process of any of Aspects 1 to 7, wherein the liquid diluent comprises one or more saturated hydrocarbons.

Aspect 9. The process of Aspect 8, wherein the one or more saturated hydrocarbons comprises a C₉ saturated hydrocarbon, a C₁₀ saturated hydrocarbon, a C₁₁ saturated hydrocarbon, or combinations thereof.

Aspect 10. The process of any of Aspects 1 to 9, wherein the polymer additive comprises an antioxidant, an antiblock additive, a surfactant, an acid scavenger, a slip additive, a colorant, a filler, a processing aid, a UV inhibitor, or any combination thereof.

Aspect 11. A polymer hopper system comprising: a hopper configured to contain a molten polymer pool; and an inlet device coupled to an inlet of the hopper, wherein the inlet device is configured to: i) receive a feed stream comprising a molten polymer, a liquid diluent, a polymer additive, and unreacted monomer, ii) provide one or more solid surfaces for incorporating the polymer additive into the molten polymer, and iii) direct the molten polymer and the polymer additive into the molten polymer pool.

Aspect 12. The polymer hopper system of Aspect 11, wherein a bottom of the inlet device is above a top surface of the molten polymer pool.

Aspect 13. The polymer hopper system of Aspect 11 or 12, wherein the inlet device is further configured to reduce a velocity of the feed stream.

Aspect 14. The polymer hopper system of any of Aspects 11 to 13, wherein the liquid diluent vaporizes in the inlet device to form a vaporized diluent, wherein the velocity of the feed stream is reduced within the inlet device to prevent transport of the polymer additive into the vaporized diluent.

Aspect 15. The polymer hopper system of any of Aspects 11 to 14, wherein the hopper has an inlet on a side of the hopper, a vapor outlet on a top of the hopper, and a molten mix outlet on a bottom of the hopper, the system further comprising: a molten polymer stream fluidly coupled to the inlet of the hopper; and a polymer additive injector coupled to the inlet of the hopper.

Aspect 16. The polymer hopper system of Aspect 15, wherein the molten mix outlet is configured to fluidly communicate with a polymer extruder.

Aspect 17. The polymer hopper system of any of Aspects 11 to 16, wherein the hopper has a cylindrical portion and a conical portion, wherein the cylindrical portion is above the conical portion, wherein the inlet device is connected to an inner wall of the hopper in the cylindrical portion of the hopper.

Aspect 18. The polymer hopper system of any of Aspects 11 to 17, wherein the inlet device comprises an inlet shroud, an inlet pipe coupled to a cyclone separator, or an inlet pipe coupled with a vapor liquid gravity separator.

Aspect 19. The polymer hopper system of any of Aspects 11 to 17, wherein the inlet device comprises an inlet shroud comprising: a first portion having an end fluidly coupled with the inlet of the hopper; and a second portion having i) an end connected to an opposite end of the first portion, and ii) an opposite end that is the outlet end of the inlet shroud, wherein the first portion has a top piece, a bottom piece, a side piece, and an opposite side piece, wherein the side piece of the first portion is a portion of the inner wall of the hopper, wherein the second portion has a top piece, a side piece, and an opposite side piece, wherein the side piece of the second portion is a portion of the inner wall of the hopper, and wherein the second portion of the inlet shroud has no bottom piece.

Aspect 20. The polymer hopper system of Aspect 19, wherein a width of the inlet shroud increases in a direction that is from an inlet end of the inlet shroud to an outlet end of the inlet shroud.

Aspect 21. A polymer hopper system that can include a hopper configured to contain a molten polymer pool; and an inlet shroud. The inlet shroud comprises a first portion having an end fluidly coupled with the inlet of the hopper; and a second portion having i) an end connected to an opposite end of the first portion, and ii) an opposite end that is open to an interior of the hopper. The first portion has a top piece, a bottom piece, a side piece, and an opposite side piece, wherein the side piece of the first portion is a portion of an inner wall of the hopper. The second portion has a top piece, a side piece, and an opposite side piece, wherein the side piece of the second portion is another portion of the inner wall of the hopper. A bottom of the second portion is open to the interior of the hopper.

Aspect 22. The polymer hopper system of Aspect 21, wherein a width of the inlet shroud increases in a direction that is from an inlet end of the inlet shroud to an outlet end of the inlet shroud.

Aspect 23. The polymer hopper system of Aspect 21 or 22, wherein a bottom of the inlet shroud is above a top surface of the molten polymer pool.

Aspect 24. The polymer hopper system of any of Aspects 21 to 23, wherein the inlet shroud is configured to i) receive a feed stream comprising a molten polymer, a liquid diluent, a polymer additive, and unreacted monomer, ii) provide one or more solid surfaces for incorporating the polymer additive into the molten polymer, and iii) direct the molten polymer and the polymer additive into the molten polymer pool.

Aspect 25. The polymer hopper system of Aspect 24, wherein the inlet shroud is further configured to reduce a velocity of the feed stream.

Aspect 26. The polymer hopper system of any of Aspects 24 to 25, wherein the liquid diluent vaporizes in the inlet shroud to form a vaporized diluent, wherein the velocity of the feed stream is reduced within the inlet shroud to prevent transport of the polymer additive into the vaporized diluent.

Aspect 27. The polymer hopper system of any of Aspects 21 to 26, wherein the hopper has an inlet on a side of the hopper, a vapor outlet on a top of the hopper, and a molten mix outlet on a bottom of the hopper, the system further comprising: a molten polymer stream fluidly coupled to the inlet of the hopper; and a polymer additive injector coupled to the inlet of the hopper.

Aspect 28. The polymer hopper system of Aspect 27, wherein the molten mix outlet is configured to fluidly communicate with a polymer extruder.

Aspect 29. The polymer hopper system of any of Aspects 21 to 28, wherein the hopper has a cylindrical portion and a conical portion, wherein the cylindrical portion is above the conical portion, wherein the inlet shroud is connected to an inner wall of the hopper in the cylindrical portion of the hopper.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A process comprising:
injecting a slurry comprising a liquid diluent and a polymer additive into a polymer stream comprising a molten polymer and unreacted monomer, to form a feed stream comprising the molten polymer, the slurry, and the unreacted monomer;
introducing the feed stream into a hopper;
withdrawing, from the hopper, a molten mix comprising the molten polymer and the polymer additive; and
extruding the molten mix into a polymer extrudate.

2. The process of claim 1, wherein introducing comprises:
flowing the feed stream into an inlet device, wherein the inlet device is coupled to an inlet of the hopper.

3. The process of claim 2, further comprising:
incorporating the polymer additive into the molten polymer while the molten polymer is present in the inlet device.

4. The process of claim 3, further comprising:
directing, by the inlet device, the molten polymer and the polymer additive into a molten polymer pool contained in the hopper below the inlet device.

5. The process of claim 2, further comprising:
vaporizing the liquid diluent within the inlet device to form a vaporized diluent; and
recovering, from the hopper, a vapor stream comprising the unreacted monomer and the vaporized diluent.

6. The process of claim 2, wherein the inlet device comprises an inlet shroud, an inlet pipe coupled to a cyclone separator, or an inlet pipe coupled with a vapor liquid gravity separator.

7. The process of claim 1, wherein the molten polymer comprises a low density polyethylene, wherein the liquid diluent comprises one or more saturated hydrocarbons.

8. The process of claim 7, wherein the one or more saturated hydrocarbons comprises a C₉ saturated hydrocarbon, a C₁₀ saturated hydrocarbon, a C₁₁ saturated hydrocarbon, or combinations thereof.

9. The process of claim 7, wherein the polymer additive comprises an antioxidant, an antiblock additive, a surfactant, an acid scavenger, a slip additive, a colorant, a filler, a processing aid, a UV inhibitor, or any combination thereof.

10. A polymer hopper system comprising:
a hopper configured to contain a molten polymer pool; and
an inlet device coupled to an inlet of the hopper, wherein the inlet device is configured to: i) receive a feed stream comprising a molten polymer, a liquid diluent, a polymer additive, and unreacted monomer, ii) provide one or more solid surfaces for incorporating the polymer additive into the molten polymer, and iii) direct the molten polymer and the polymer additive into the molten polymer pool.

11. The polymer hopper system of claim 10, wherein a bottom of the inlet device is above a top surface of the molten polymer pool.

12. The polymer hopper system of claim 10, wherein the inlet device is further configured to reduce a velocity of the feed stream.

13. The polymer hopper system of claim 12, wherein the liquid diluent vaporizes in the inlet device to form a vaporized diluent, wherein the velocity of the feed stream is reduced within the inlet device to prevent transport of the polymer additive into the vaporized diluent.

14. The polymer hopper system of claim 10, wherein the hopper has an inlet on a side of the hopper, a vapor outlet on a top of the hopper, and a molten mix outlet on a bottom of the hopper, the polymer hopper system further comprising:
a molten polymer stream fluidly coupled to the inlet of the hopper; and
a polymer additive injector coupled to the inlet of the hopper.

15. The polymer hopper system of claim 14, wherein the molten mix outlet is configured to fluidly communicate with a polymer extruder.

16. The polymer hopper system of claim 10, wherein the hopper has a cylindrical portion and a conical portion, wherein the cylindrical portion is above the conical portion, wherein the inlet device is connected to an inner wall of the hopper in the cylindrical portion of the hopper.

17. The polymer hopper system of claim 10, wherein the inlet device comprises an inlet shroud, an inlet pipe coupled to a cyclone separator, or an inlet pipe coupled with a vapor liquid gravity separator.

18. The polymer hopper system of claim 10, wherein the inlet device comprises an inlet shroud comprising:
a first portion having an end fluidly coupled with the inlet of the hopper; and
a second portion having i) an end connected to an opposite end of the first portion, and ii) an opposite end that is open to an interior of the hopper,
wherein the first portion has a top piece, a bottom piece, a side piece, and an opposite side piece, wherein the side piece of the first portion is a portion of an inner wall of the hopper,
wherein the second portion has a top piece, a side piece, and an opposite side piece, wherein the side piece of the second portion is another portion of the inner wall of the hopper, and
wherein a bottom of the second portion is open to the interior of the hopper.

19. The polymer hopper system of claim 18, wherein a width of the inlet shroud increases in a direction that is from an inlet end of the inlet shroud to an outlet end of the inlet shroud.

20. A polymer hopper system comprising:
a hopper configured to contain a molten polymer pool; and
an inlet device coupled to an inlet of the hopper, wherein the inlet device comprises an inlet shroud comprising:
a first portion having an end fluidly coupled with the inlet of the hopper; and
a second portion having i) an end connected to an opposite end of the first portion, and ii) an opposite end that is open to an interior of the hopper,
wherein the first portion has a top piece, a bottom piece, a side piece, and an opposite side piece, wherein the side piece of the first portion is a portion of an inner wall of the hopper,
wherein the second portion has a top piece, a side piece, and an opposite side piece, wherein the side piece of the second portion is another portion of the inner wall of the hopper, and
wherein a bottom of the second portion is open to the interior of the hopper.
